(19) United States
(12) Patent Application Publication
(10) Pub. No.: US 2023/0362196 A1
(43) Pub. Date: Nov. 9, 2023

(54) MASTER POLICY TRAINING METHOD OF HIERARCHICAL REINFORCEMENT LEARNING WITH ASYMMETRICAL POLICY ARCHITECTURE

(71) Applicant: National Tsing Hua University, Hsinchu City (TW)

(72) Inventor: Chun-Yi LEE, Hsinchu City (TW)

(21) Appl. No.: 17/736,609

(22) Filed: May 4, 2022

(51) Int. Cl. H04L 9/40; H04L 41/16

(52) U.S. Cl. CPC H04L 63/20; H04L 41/16

(57) ABSTRACT

The present invention includes the following steps: loading a master policy, a plurality of sub-policies, and environment data; wherein the sub-policies have different inference costs; selecting one of the sub-policies as a selected sub-policy by using the master policy; generating at least one action signal according to the selected sub-policy; applying the at least one action signal to an action executing unit; detecting at least one reward signal from a detecting module; training the master policy using at least one real inference cost of the at least one reward signal and an expected inference cost of the selected sub-policy to minimize inference cost; the present invention trains the master policy using Hierarchical Reinforcement Learning with an asymmetrical policy architecture, thus allowing the master policy to reduce inference cost while maintaining satisfying performance for a deep neural network model.

### BACKGROUND OF THE INVENTION

### 1. Field of the Invention

The present invention relates to a master policy training method of Hierarchical Reinforcement Learning (HRL), more particularly a master policy training method of HRL with asymmetrical policy architecture.

### 2. Description of the Related Art

In modern society, robots and machines are increasingly tasked to perform complicated actions, such as performing balancing motions, imitating complicated human motions, and automating vehicle accelerations, etc. These complicated controls require machine learning methods on a software level.

In the realm of machine learning, Reinforcement Learning (RL) is a training process for decision making based on maximizing a cumulative reward. When a decision is made, an action is performed in an environment based on the made decision, and a result of the action is collected as a reward. When multiple actions are performed, multiple results are collected as the cumulative reward used for further training on decision making.

Deep neural networks (DNN) is another machine learning method used for multi-layered decision making considerations. When combining RL and DNN, a method known as Deep Reinforcement Learning (DRL) is further created to make breakthroughs in controlling robots to make complicated actions.

However, to produce satisfying results, DRL costs a lot of computational power. More particularly, when a DNN model is being used, an inference phase of the DNN model is a computationally-intensive process. As a result, robots with limited computational power such as a mobile robot, would fall short and be unable to perform the inference phase as intended.

To compensate the limitation of computation power, a method known as pruning is often used to reduce a size of DNN models and alleviate the computation power needed. However, with less logical architecture to consider, an end result would often be negatively affected. Pruning may alleviate the computation power required, but at an expense of sacrificing inference correctness for decision making. In addition, pruning may also risk making a logical structure of the DNN model unstable, and may require even more effort to make sure the DNN model is intact after pruning.

Another method known as distillation is also used to reduce inference cost of the inference phase. Distillation allows a teacher DNN to teach a student DNN how to complete a task with reduced inference cost. For example, the teacher DNN may have a larger logical structure size, and the student DNN may have a smaller logical structure size. The student DNN may also shorten an overall deployment time of a program. With less deployment time, the inference phase is shortened, and the inference cost is thereby reduced. However, distillation requires the student DNN to be trained from the teacher DNN. In other words, the student DNN is dependent upon the teacher DNN to learn how to perform the task, and such dependency is inconvenient to develop the student DNN.

Hierarchical Reinforcement Learning (HRL) is an RL architecture concept of having a policy on a higher order over multiple sub-policies on a lower order. The sub-policies are geared for executing temporally extended actions to solve multiple sub-tasks. The sub-tasks, in regard to performing previously mentioned complicated actions, can figure out what actions are required for balancing motions, how high a hand should be raised to imitate complicated human motions, and how much a vehicle should be accelerated to reach a destination, etc. So far, HRL methods are employed for solving complicated problems with increased inference cost, and HRL is yet to be used to reduce inference cost of DNN.

In conclusion, currently HRL and DRL focus on having DNNs to solve complicated problems with increased inference cost. To reduce the inference cost, several methods such as pruning and distillation are currently being used. Pruning reduces the size of the DNN model to simplify the decision making process at the expense of losing logical structure. As a result, pruning sacrifices inference correctness and structural stability of the DNN model to reduce the overall inference cost.

Distillation requires the student DNN to be trained by the teacher DNN. This, however, requires the student DNN to be dependent upon the teacher DNN, and such dependency makes developing the student DNN to perform the task inconvenient.

### SUMMARY OF THE INVENTION

The present invention provides a master policy training method of HRL with an asymmetrical policy architecture. The master policy training method of HRL with an asymmetrical policy architecture is executed by a processing module.

The master policy training method of HRL with an asymmetrical policy architecture includes steps of:
loading a master policy, a plurality of sub-policies, and environment data; wherein the sub-policies have different inference costs;
selecting one of the sub-policies as a selected sub-policy by using the master policy;
generating at least one action signal according to the selected sub-policy;
applying the at least one action signal to an action executing unit;
detecting at least one reward signal from a detecting module; wherein the at least one reward signal corresponds to at least one reaction of the action executing unit responding to the at least one action signal; and
calculating a master reward signal of the master policy according to the at least one reward signal and an inference cost of the selected sub-policy;
training the master policy by selecting the sub-policy according to the master reward signal.

The present invention uses an HRL structure to have the master policy make policy over options decision, wherein the options are the sub-policies. However, different from prior arts, in the present invention the master policy is independently trained apart from the sub-policies. The master policy is independently trained to solely make decisions on selecting which of the sub-policies is to be used to generate the at least one action signal. This also allows a possibility for the sub-policies to be independently trained from the master policy. As such, the present invention allows the sub-policies to be more conveniently trained and developed independently.

The overall inference cost refers to an overall computational cost for a processing module using the present invention to complete a task. Namely, in an embodiment of the present invention, the processing module is trained by the present invention to control the action executing unit, for example, a robotic arm, to perform the task of snatching an object and moving the object to a destination. During this process, multiple actions will be executed and more than one sub-policies will be used for the robotic arm to snatch the object and move the object to the destination. The overall inference cost in this case refers to the overall computational cost for executing multiple actions and using at least one sub-policy for the robotic arm to successfully snatch the object and move the object to the destination.

Furthermore, the present invention utilizes the asymmetric architecture of having the sub-policies with different inference costs. The present invention only uses the sub-policies with higher cost when deemed necessary by the master policy, keeping the overall inference cost as low as possible without hindering performance. Through experimental simulations, discoveries are made through the detecting module that the action executing unit produces satisfying results when given the at least one action signal from the processing module.

Since the present invention is able to lower the overall inference cost without pruning any of the sub-policies responsible for generating the at least one action signal, logical contents for decision making are all preserved. This way the present invention is able to lower the overall inference cost without sacrificing inference correctness and structural stability of the training model.

### BRIEF DESCRIPTION OF THE DRAWINGS

FIG. 1 is a block diagram of hardware executing a master policy training method of Hierarchical Reinforcement Learning (HRL) with an asymmetrical policy architecture of the present invention.

FIG. 2 is a flow chart of the master policy training method of HRL with an asymmetrical policy architecture of the present invention.

FIG. 3 is another flow chart of the master policy training method of HRL with an asymmetrical policy architecture of the present invention.

FIG. 4 is a perspective view of the master policy training method of HRL with an asymmetrical policy architecture of the present invention.

FIG. 5 is another flow chart of the master policy training method of HRL with an asymmetrical policy architecture of the present invention.

FIG. 6 is another flow chart of the master policy training method of HRL with an asymmetrical policy architecture of the present invention.

FIG. 7 is another flow chart of the master policy training method of HRL with an asymmetrical policy architecture of the present invention.

FIG. 8 is another flow chart of the master policy training method of HRL with an asymmetrical policy architecture of the present invention.

FIG. 9 is another perspective view of the master policy training method of HRL with an asymmetrical policy architecture of the present invention.

FIG. 10 is a flow chart of a controller program trained by the master policy training method of HRL with an asymmetrical policy architecture of the present invention.

FIG. 11 is a perspective view of an experimental simulation of the master policy training method of HRL with an asymmetrical policy architecture of the present invention.

FIG. 12A is a perspective view of another experimental simulation of the master policy training method of HRL with an asymmetrical policy architecture of the present invention.

FIG. 12B is a perspective view of still another experimental simulation of the master policy training method of HRL with an asymmetrical policy architecture of the present invention.

FIG. 12C is a perspective view of yet another experimental simulation of the master policy training method of HRL with an asymmetrical policy architecture of the present invention.

### DETAILED DESCRIPTION OF THE INVENTION

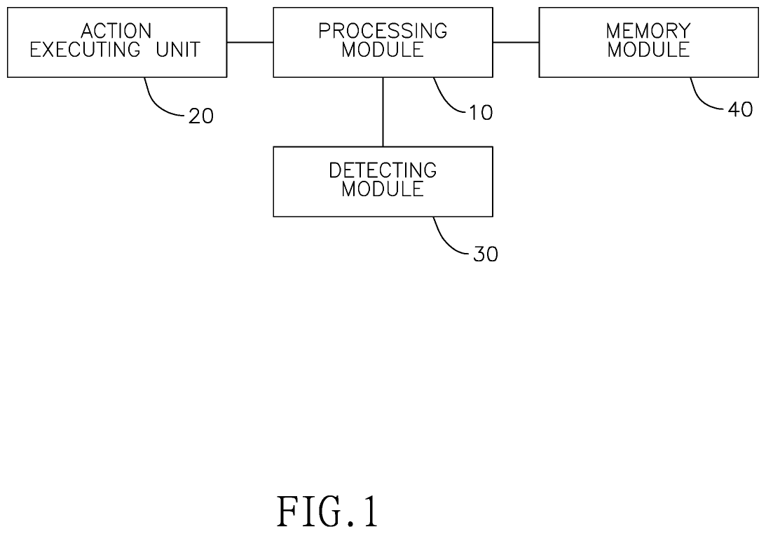

With reference to FIG. 1, the present invention provides a master policy training method of Hierarchical Reinforcement Learning (HRL) with an asymmetrical policy architecture. The master policy training method of HRL with an asymmetrical policy architecture of the present invention is executed by a processing module 10. The processing module 10 is electrically connected to an action executing unit 20 and a detecting module 30.

In an embodiment of the present invention, the processing module 10 is also electrically connected to a memory module 40. The memory module 40 stores a master policy and a plurality of sub-policies.

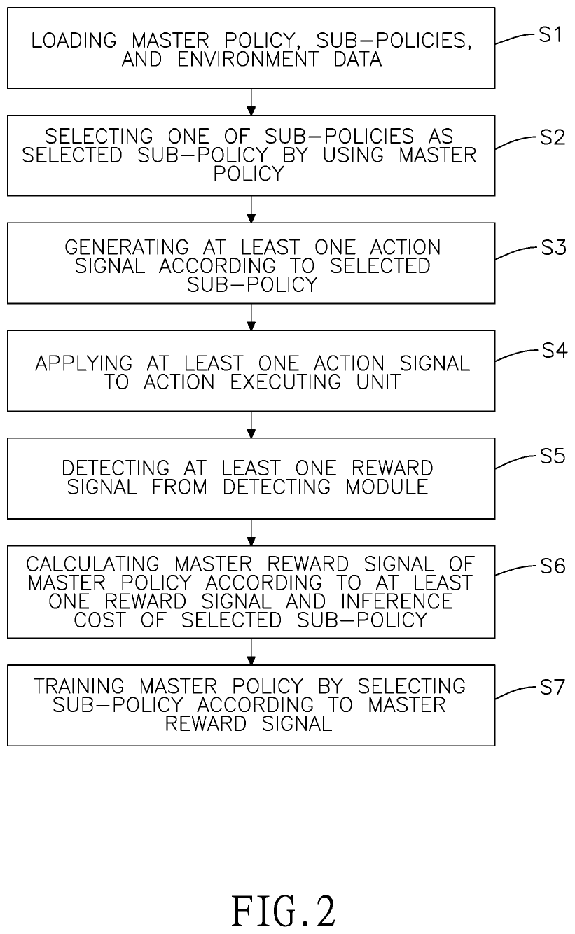

With reference to FIG. 2, the master policy training method of HRL with an asymmetrical policy architecture includes the following steps:

Step S1: loading the master policy and the plurality of sub-policies from the memory module 40, and loading environment data from the detecting module 30.

The plurality of sub-policies include a first policy and a second policy, and therefore the first policy and the second policy are sub-policies to the master policy. The first policy and the second policy have different inference costs; more particularly, the first policy has less inference cost than the second policy.

Step S2: selecting one of the sub-policies as a selected sub-policy by using the master policy.

Step S3: generating at least one action signal according to the selected sub-policy.

Step S4: applying the at least one action signal to the action executing unit 20.

Step S5: detecting at least one reward signal from the detecting module 30. The at least one reward signal corresponds to at least one reaction of the action executing unit 20 responding to the at least one action signal.

The action executing unit 20 receives orders from the at least one action signal from the processing module 10 to perform a task. How well the task is performed will be reflected by the at least one reward signal detected through the detecting module 30.

Step S6: calculating a master reward signal of the master policy according to the at least one reward signal and an inference cost of the selected sub-policy.

Step S7: training the master policy by selecting the sub-policy according to the master reward signal.

The inference cost of the selected sub-policy is predefined and stored in the memory module 40. The master reward signal is formulated according to observations perceived by the master policy through the detecting module 30. More particularly, the master reward signal is formulated to rate how appropriate the selected sub-policy is for generating at least one action to perform the task. Once formulated, the master reward signal is then used to guide the master policy to select a more appropriate sub-policy to perform the task.

The present invention uses an HRL structure to have the master policy make policy over options decision, wherein the options are the sub-policies. The master policy is independently trained apart from the sub-policies. In other words, the master policy is independently trained to solely make decisions on selecting which of the sub-policies is to be used to generate the at least one action signal. This reduces an overall inference cost by dynamically adjusting the appropriate sub-policy to perform the task without sacrificing quality of performance. This way, the present invention avoids having only one large cost policy to perform the task. Although using a large cost policy to perform the task often results in good performance quality, the overall inference cost, however, is often too high. Therefore, by having the sub-policies with different costs to choose from, the present invention is able to more flexibly choose one of the sub-policies to perform the task. Because of this flexibility, the present invention is able to reduce the overall inference cost without sacrificing performance quality. By having the master policy to make policy over options decisions, the present invention is able to find a balance between maintaining performance quality of the task and using the appropriate sub-policy with as low inference cost as possible, and hence reduce the overall inference cost to perform the task.

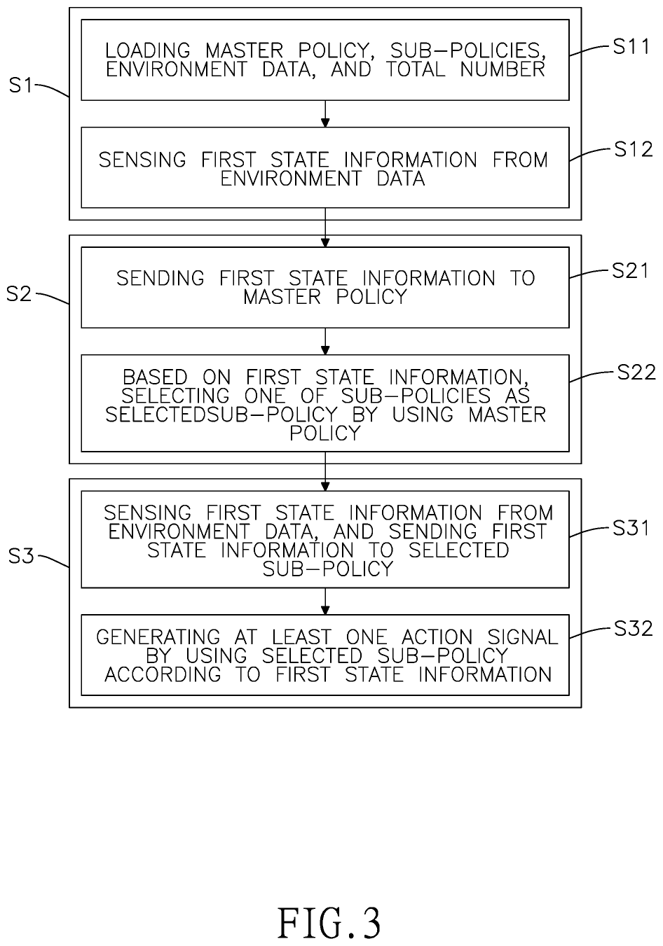

With reference to FIG. 3, in the current embodiment, step S1 further includes the following sub-steps:

Step S11: loading the master policy, the plurality of sub-policies, and a total number from the memory module 40, and loading environment data from the detecting module 30, wherein the total number is a positive integer.

Step S12: sensing a first state information from the environment data.

Furthermore, step S2 also comprises the following sub-steps:

Step S21: sending the first state information to the master policy.

Step S22: based on the first state information, selecting one of the sub-policies as the selected sub-policy by using the master policy.

Furthermore, step S3 also comprises the following sub-steps:

Step S31: sensing the first state information from the environment data, and sending the first state information to the selected sub-policy.

Step S32: generating the at least one action signal by using the selected sub-policy according to the first state information.

In this embodiment, although the master policy is given the first state information, the master policy only selects one of the sub-policies as the selected sub-policy. In other words, the master policy omits passing the first state information to the selected sub-policy, and hence step S31 is required to sense the first state information for the selected sub-policy. The environment data is time dependent; in other words, the state information sensed from the environment data changes with time.

The environment data is data of an environment detected by the detecting module 30. In other words, the environment data is extraction of data from the environment. In an embodiment of the present invention, the environment is a real physical environment, and the detecting module 30 is a physical sensor, such as a camera or a microphone. In another embodiment, the environment is a virtual environment, and the detecting module 30 is a processor that simulates the virtual environment. The simulated virtual environment may also be interactive, meaning the environment in this case is dynamically changing over time. Since a state of the environment changes over time, and depending on the state of the environment, different actions are required for the action executing unit 20. In this sense, different sub-policies with different costs would likely be selected to more appropriately generate actions required for the action executing unit 20 in various situations.

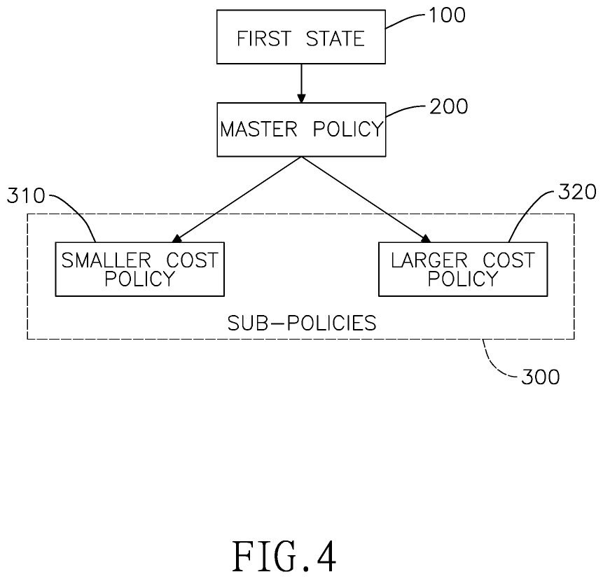

With reference to FIG. 4, in a perspective view of the present invention, the first state information 100 is first given to the master policy 200, and the master policy 200 then decides which one of the sub-policies 300 would be selected. Once selected, only the selected sub-policy is used by the master policy 200 for generating the at least one action signal for a set duration of time. The first policy 310 is represented as a smaller cost policy, and the second policy 320 is represented as a larger cost policy, wherein the cost refers to the inference cost of making decisions based on the sensed first state information 100. The asymmetric architecture of the present invention refers to the first policy 310 having less inference cost than the second policy 320. The present invention only uses the second policy 320 when deemed necessary by the master policy 200, keeping the overall inference cost as low as possible without hindering a quality of performance. In other words, by default the present invention uses the first policy 310 to generate the action, and only when faced with complex decision making scenarios when high inference cost is inevitable will the present invention use the second policy 320 to generate the action. The complex decision making scenarios will be further discussed in examples.

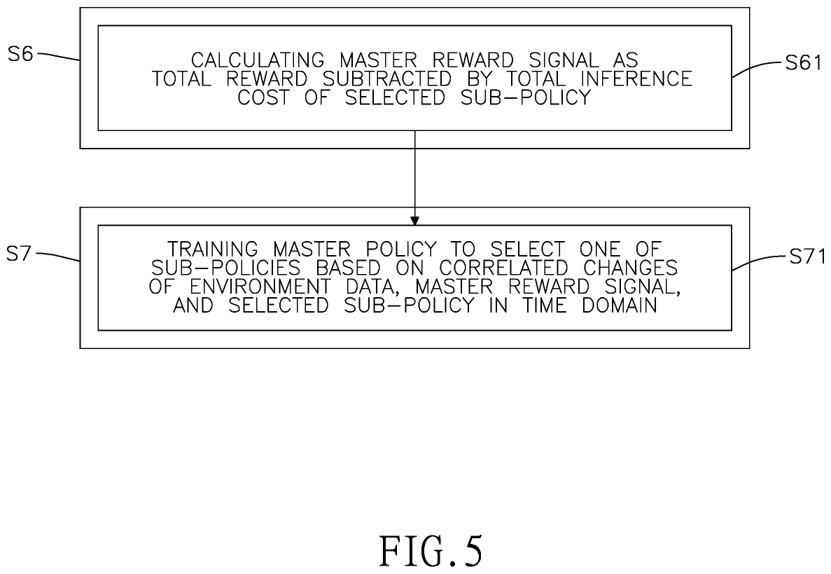

With reference to FIG. 5, in the current embodiment, step S6 further includes the following sub-step:

Step S61: calculating the master reward signal as a total reward subtracted by a total inference cost of the selected sub-policy for a usage time duration of the selected sub-policy.

The total reward is a sum of all the at least one reward signal for the usage time duration of the selected sub-policy. The total inference cost of the selected sub-policy correlates to the inference cost of the selected sub-policy and the usage time3 duration of the selected sub-policy. The usage time duration of the selected sub-policy is how long the selected sub-policy is chosen for use.

Step S7 further includes the following sub-step:

Step S71: training the master policy 200 to select one of the sub-policies 300 based on changes of the environment data, the master reward signal, and the selected sub-policy in time domain.

In other words, the present invention monitors changes of how high of a score can the master reward signal produce according to the selected sub-policy. The higher the score, the more suitable and ideal the selected sub-policy is to be selected by the master policy 200 for the state. Vice versa, the lower the score, the less suitable and ideal the selected sub-policy is to be selected for the state by the master policy 200. This revelation is used to train the master policy 200 to dynamically make adjustments of what inputs produce the best output, inputs being the selected sub-policy for the state, and output being the master reward signal. The state is correlated to the environment data, as the state is sensed from the environment data.

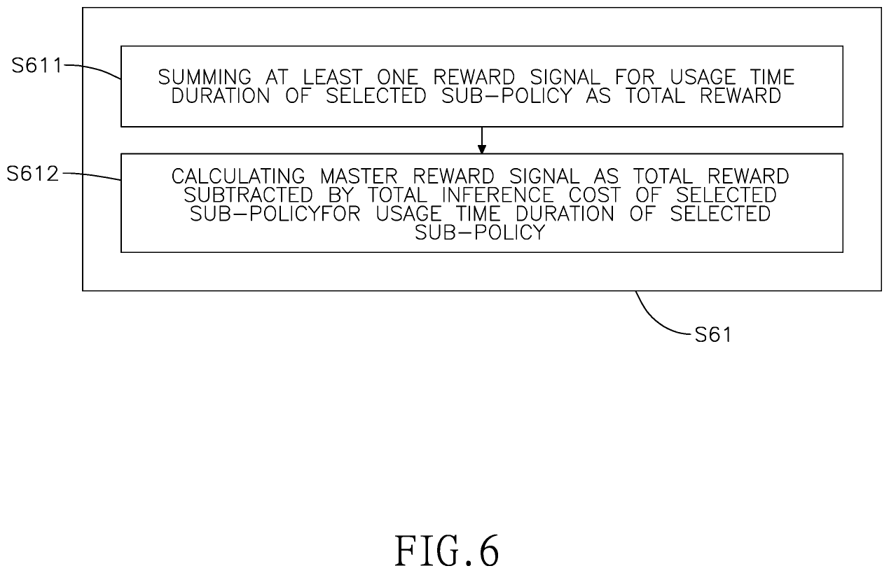

With reference to FIG. 6, step S61 further includes the following sub-steps:

Step S611: summing the at least one reward signal for the usage time duration of the selected sub-policy as the total reward.

Step S612: calculating the master reward signal as the total reward subtracted by the total inference cost of the selected sub-policy for the usage time duration of the selected sub-policy.

The total inference cost of the selected sub-policy equals to the inference cost of the selected sub-policy multiplied by a scaling factor and a time period. The time period is pre-defined and stored in the memory module 40 as how long the selected sub-policy is used before having the master policy 200 to decide choosing one of the sub-policies 300 to use again. The time period equals how many times the selected sub-policy performs actions multiplied by a time length of an action. The inference cost of the selected sub-policy may be represented in different terms. In this embodiment, the inference cost of the selected sub-policy is measured as power consumption rate, in units such as Watts (W). In another embodiment, the inference cost of the selected sub-policy is measured as computation time, in time units. In yet another embodiment, the inference cost of the selected sub-policy is measured as computational performance, for example in units such as Floating-point operations per second (FLOPS), or in any other units measured in countable operations per second.

The memory module 40 stores the time period, the time length of an action, and the inference cost for each of the sub-policies 300. For example, a first inference cost of the first policy 310 and a second inference cost of the second policy 320 would be stored in the memory module 40. When the first policy 310 is selected as the selected sub-policy, the first inference cost will be loaded from the memory module 40 to the processing module 10.

As a reminder, the first inference cost is different from the total inference cost. The total inference cost is affected by the scaling factor and the time period. In other words, the more time the selected sub-policy is used to generate the at least one action signal, the more the total inference cost increases.

In this embodiment, the greater the master reward signal is, the more ideal the master policy 200 is scored for selecting at least one sub-policy 300 as the selected sub-policy to perform the task with the best balance. The best balance means having the total reward as high as possible while having the total inference cost as low as possible for the entire execution of the task. The best balance is achieved by using at least one sub-policy 300 as the selected sub-policy to perform the task with the highest yielding score for the master reward signal.

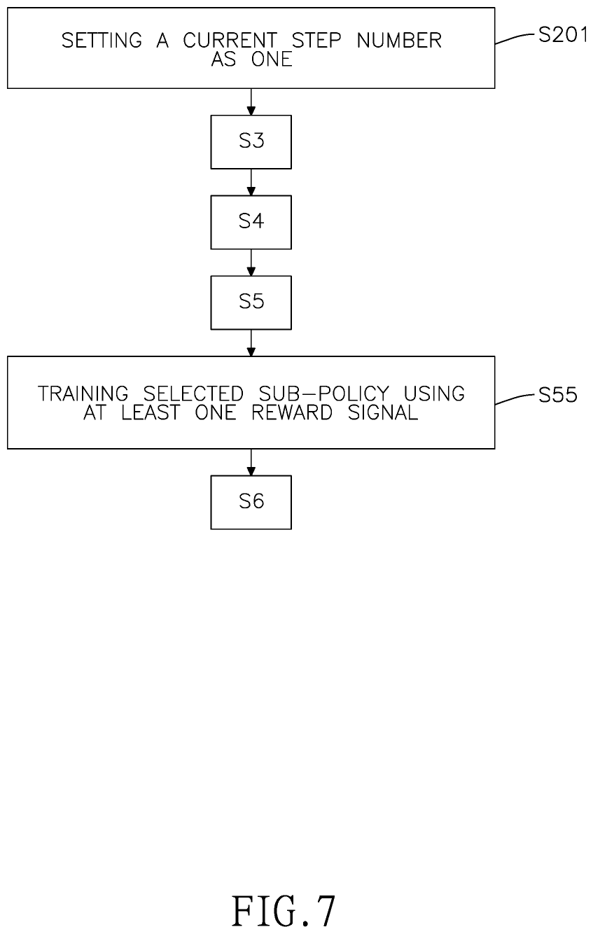

With reference to FIG. 7, in another embodiment of the present invention, between step S5 and step S6 further includes the following step:

Step S55: training the selected sub-policy using the at least one reward signal. The selected sub-policy is trained to produce as high score as possible for completing the task according to the at least one reward signal. In other words, step S55 trains the selected sub-policy to perform the task better.

Furthermore, the processing module 10 repeats executing steps S3 to S5 for N times, wherein N equals the total number.

More specifically, before executing step S3, the master policy training method further includes a step of:

Step S201: setting a current step number as one.

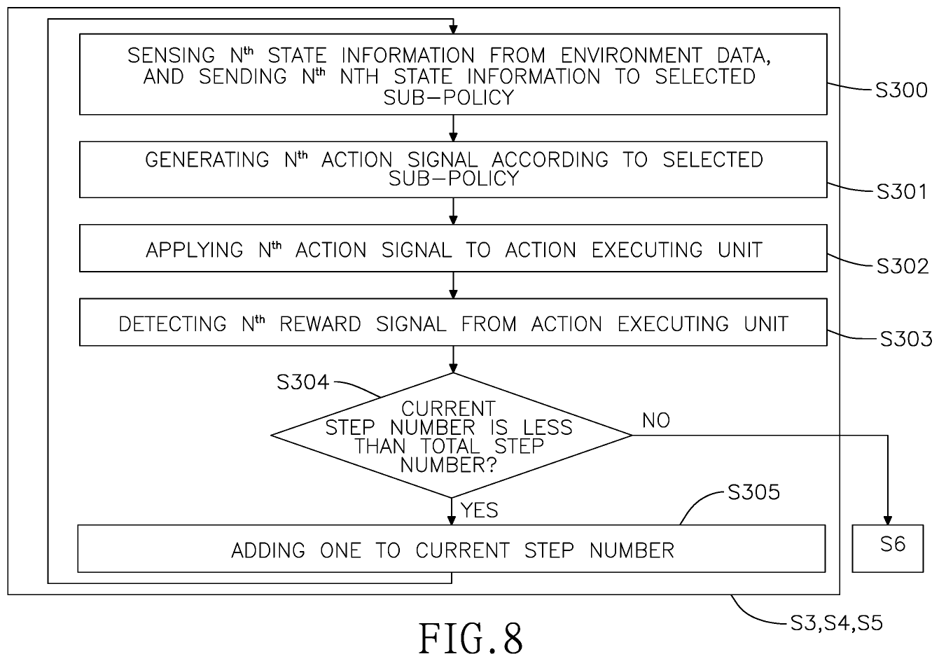

With reference to FIG. 8, in the embodiment, steps S3 to S5 are equivalent to the following sub-steps:

Step S300: sensing an N^{th} state information from the environment data, and sending the N^{th} state information to the selected sub-policy.

Step S301: generating an N^{th} action signal according to the selected sub-policy.

Step S302: applying the N^{th} action signal to the action executing unit.

Step S303: detecting an N^{th} reward signal from the detecting module 30.

The aforementioned N equals an order corresponding to the current step number, and the N^{th} reward signal corresponds to a reaction of the action executing unit responding to the N^{th} action signal.

Step S304: determining whether the current step number is less than the total step number; when determining the current step number is greater than or equal to the total step number, executing step S6.

Step S305: when determining the current step number is less than the total step number, adding one to the current step number, and executing step S300.

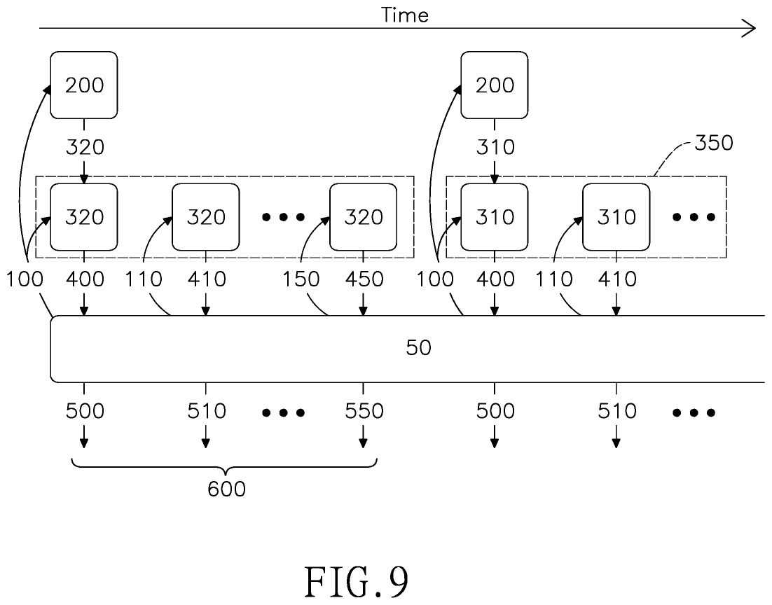

With reference to FIG. 9, a perspective view is presented as a visual representation of the present invention. The environment 50 is detected by the detecting module 30 and loaded into the processing module 10. The state of the action executing unit 20 is reflected through the environment data extracted from the environment 50. The processing module 10 extracts the first state information 100 from the environment 50. In this embodiment, the processing module 10 first uses the master policy 200 to select the second policy 320 as the selected sub-policy 350. The processing module 10 then uses the second policy 320 to generate the first action 400 to the action executing unit 20. As a result, a first reward signal 500 is detected from the environment 50. After the period of time has passed, a second state 110 is sensed from the environment 50 by the processing module 10. The second state 110 is given to the selected sub-policy 350, here as the second policy 320, to generate another action, here represented as a second action 410, towards the action executing unit 20. Another reward signal, here represented as a second reward signal 510, is detected from the environment 50. When the current step number is less than the total step number, steps are repeated to sense from the environment 50 and generate successive reward signals. When the current step number equals the total step number, a final state 150 is sensed from the environment 50 and given to the selected sub-policy 350. A final action 450 is generated by the selected sub-policy 350 to the action executing unit 20. A final reward signal 550 is detected from the environment 50 and saved in the memory module 40.

All of the reward signals 500, 510, . . . , 550 are used by the processing module 10 for training the selected sub-policy 350. All of the reward signals 500, 510, . . . , 550 are summed as the total reward and subtracted by the total inference cost of the selected sub-policy for the usage time duration of the selected sub-policy by the processing module 10 to calculate the master reward signal 600. The master reward signal 600 is then used by the processing module 10 for training the master policy 200.

Afterwards, the processing module 10 executes step S2 again, and starts another cycle of steps wherein the first policy 310 is selected by the master policy 200 as the selected sub-policy 350.

The following formula describes how the master reward signal 600 is calculated:

$${r}_{m} = ( {r}_{0} + {r}_{1} + … + {r}_{n - 1} ) - λ * n * {c}_{s}$$

$${r}_{m} = {\sum }_{i = 0}^{n - 1} {r}_{i} - λ * {n}_{tp} * {c}_{s}$$

The symbol rₘ represents the master reward signal 600, the symbol r₀ represents the first reward signal 500, the symbol r₁ represents the second reward signal 510, and the rₙ₋₁ represents the final reward signal 550. The symbol λ represents the scaling factor, the symbol nₜₚ represents time period, and the symbol cₛ represents the inference cost for the selected sub-policy 350. In this embodiment, the inference cost for the selected sub-policy 350 is an averaged constant independent of time. In another embodiment, the inference cost for the selected sub-policy 350 is a time dependent cost, meaning that the inference cost is expected to change with time as the action executing unit 20 performs different actions.

In another embodiment of the present invention, step S55 is omitted as all of the sub-policies are already trained to perform the task. In other words, the sub-policies are pre-trained to perform the task before being stored in the memory module 40. When the plurality of sub-policies are loaded from the memory module 40 in step S1, the present invention is already equipped with the sub-policies fully capable of performing the task. The present invention allows the sub-policies to be trained independently from the master policy. In comparison to prior arts, this offers a new degree of freedom and convenience to develop and train the sub-policies. Furthermore, by training the master policy and the sub-policies independently, the present invention can be more efficiently trained to perform the task.

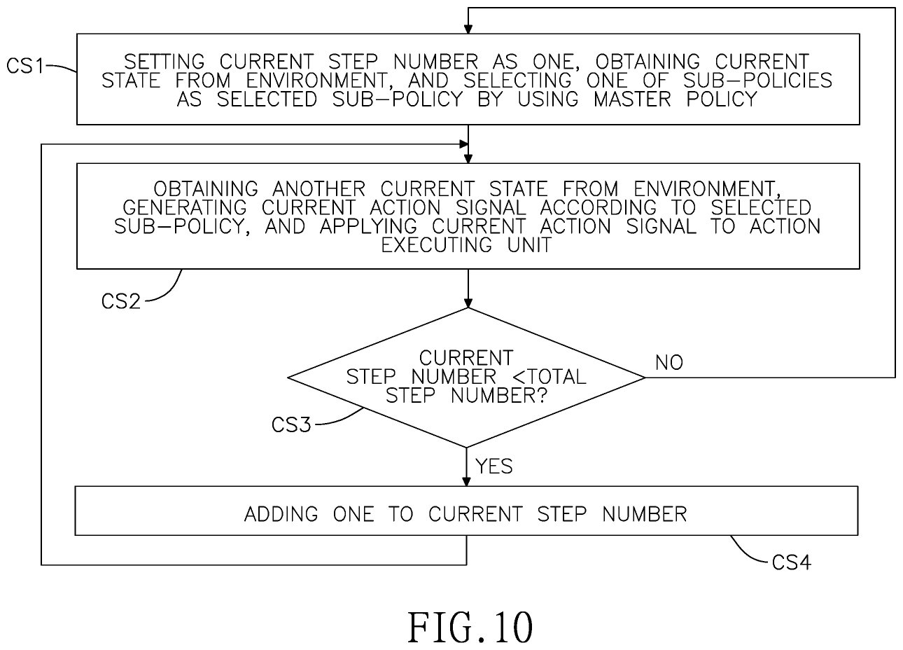

With reference to FIG. 10, in this embodiment, a controller program is trained by the present invention in a training phase to control the action executing unit 20 with the master policy 200 and the sub-policies 300 of different inference cost. After training is complete, the controller program is put into use in an executing phase in the following experiments to demonstrate the effectiveness of the present invention. After the controller program is trained by the present invention, the controller program would be able to decide which of the sub-policies 300 to choose when given the state from the environment of the experiments. The controller program purely uses results from trainings of the present invention, without further collecting any reward signals or calculating the master reward signal 600.

The controller program would execute the following steps:

Step CS1: setting a current step number as one, obtaining a current state from the environment, and selecting one of the sub-policies 300 as the selected sub-policy 350 by using the master policy 200.

Step CS2: obtaining another current state from the environment, generating a current action signal according to the selected sub-policy 350, and applying the current action signal to the action executing unit.

Step CS3: determining whether the current step number is less than the total step number; when determining the current step number is greater than or equal to the total step number, executing step CS1.

Step CS4: when determining the current step number is less than the total step number, adding one to the current step number, and executing step CS2.

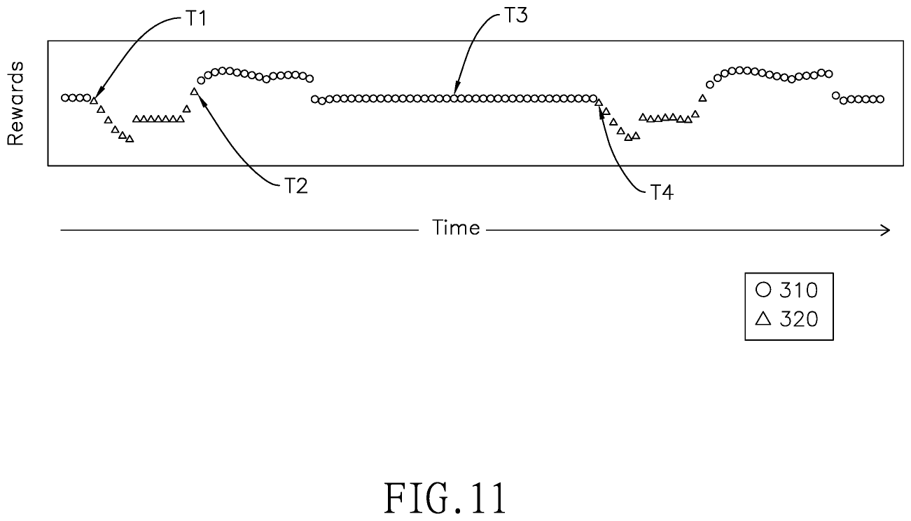

With reference to FIG. 11, in an experimental simulation of a limb of a swimmer performing a stroke, the controller program trained by the present invention is put to test for improving the simulation of performing the stroke. In FIG. 11, a horizontal axis is a measurement of time, for example, in seconds. In FIG. 11, a vertical axis is a measurement of rewards in an arbitrary unit, for example, in points. This simulation example is chosen because simulating the stroke presents a complex decision making scenario for a DNN model. In other words, the stroke is considered a complex motion to simulate, and the simulation of the stroke presents a challenge for the DNN model, thus presenting a great opportunity for the controller program trained by the present invention to demonstrate the effectiveness of the present invention in lowering the inference cost while preserving quality training results. In this example, the limb of the swimmer is being controlled by the processing module 10, the limb of the swimmer is the action executing unit 20, and movements of the limb of the swimmer are detected through the detecting module 30.

FIG. 11 presents time dependent data of when exactly the master policy 200 decides to use the first policy 310 versus the second policy 320 for generating the actions to the environment 50 in terms of the reward signals saved by the memory module 40. As a result, when simulating the limb of the swimmer performing the stroke, most of the time the first policy 310 is used. More particularly, when the limb of the swimmer starts to perform the stroke at time T1 in FIG. 11, the second policy 320 is used for generating the actions as the stroke involves complex motions. Once the stroke reaches an end at time T2 in FIG. 11, the master policy 200 switches the selected sub-policy 350 to the first policy 310 for simulating the limb of the swimmer maintaining motions after the stroke. The first policy 310 is used after the stroke as maintaining motions involves less moving parts of the limb, and thus simplifies the inference phase complexity. At time T4 in FIG. 11, the limb of the swimmer starts to perform another stroke and therefore the processing module 10 switches back to using the second policy 320. Between time T2 and time T4 in FIG. 11, time T3 in FIG. 11 signifies a period of time that the limb of the swimmer maintains motions.

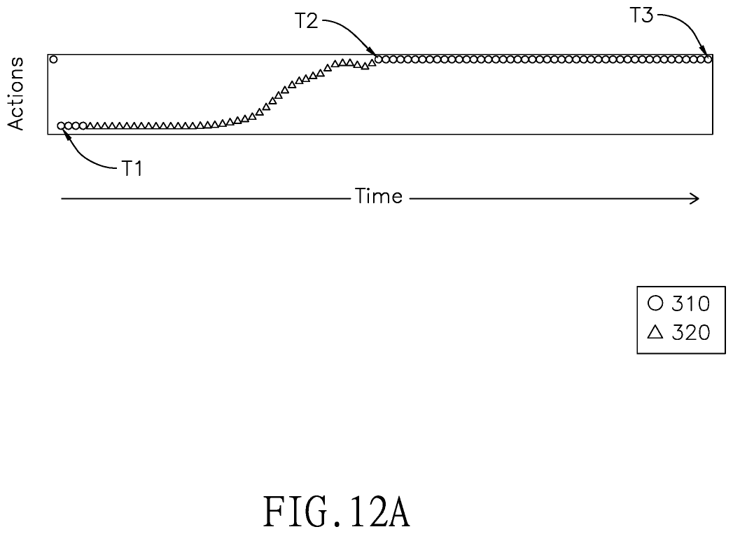

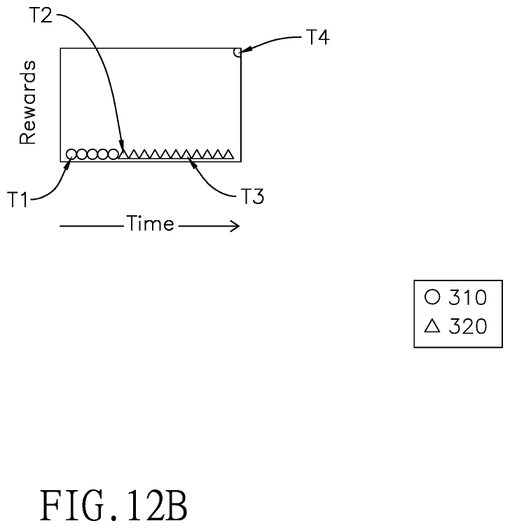

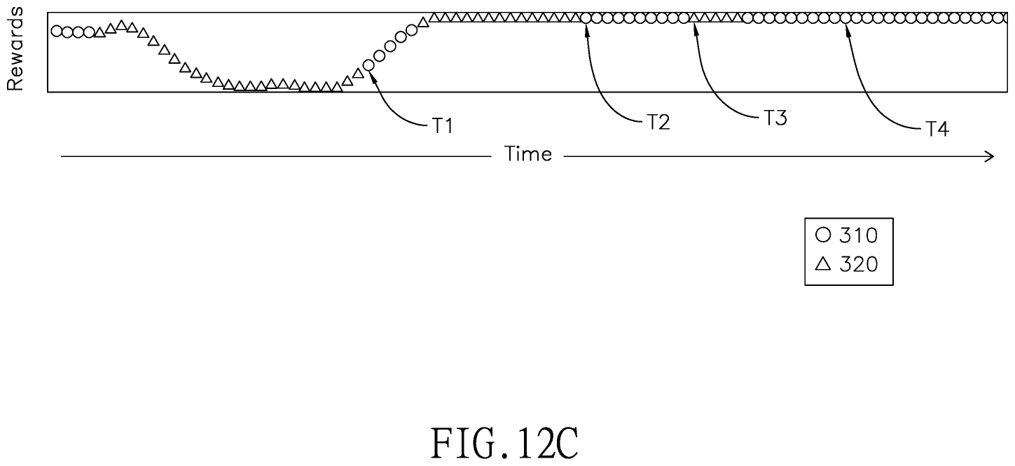

With reference to FIGS. 12A to 12C, more experimental simulations are presented. FIG. 12A presents an experimental simulation of a car driving up a hill, wherein the acceleration of the car presents another complex decision making scenario for the DNN model. In this case, the processing module 10 controls the car driving up the hill, the car is the action executing unit 20, and movements of the car are detected through the detecting module 30. FIG. 12B presents an experimental simulation of a robotic arm snatching an object and moving the object to a destination, wherein detailed movement of the robotic arm snatching the object presents another complex decision making scenario for the DNN model. In this case, the processing module 10 controls movements of the robotic arm, the robotic arm is the action executing unit 20, and movements of the robotic arm are detected through the detecting module 30. FIG. 12C presents an experimental simulation of a walker trying to maintain its stand-up posture, wherein the walker maintaining perfect balance for standing up presents another complex decision making scenario for the DNN model. In this case, the processing module 10 controls the walker, the walker is the action executing unit 20, and movements of the walker are detected through the detecting module 30. All actions of the three simulations are recorded and represented in chronological order respectively in FIGS. 12A to 12C.

In FIG. 12A, a horizontal axis is a measurement of time, for example, in seconds. In FIG. 12A, a vertical axis is a count of actions. When the car starts to increase acceleration at time T1 in FIG. 12A, the master policy 200 chooses the second policy 320 for generating actions, as deciding how much acceleration to increase requires more inference cost. When the car stops increasing accelerations at time T2 in FIG. 12A, the master policy 200 switches the selected sub-policy 350 to the first policy 310 for generating actions, as maintaining same amount of acceleration requires less inference cost. At time T3 in FIG. 12A, the car finally reaches destination and stops. Between time T2 and T3 in FIG. 12, the car maintains constant acceleration.

In FIG. 12B, a horizontal axis is a measurement of time, and a vertical axis is a measurement of rewards in an arbitrary unit, for example, in points. Before the robotic arm contacts the object at time T1 in FIG. 12B, the robotic arm only needs macro movements for translation, and therefore requires only the first policy 310 for generating actions. Once the robotic arm contacts the object at time T2 in FIG. 12B, the robotic arm starts to require micro movements to handle the object, and therefore requires the second policy 320 for generating actions. Macro movements here refer to coarse adjustments of movements, while micro movements here refer to fine adjustments of movements. Detail definitions for coarse or fine adjustments of movements may be defined according to different experimental setups. Before the robotic arm contacts the object, the master policy 200 chooses the first policy 310 as the selected sub-policy 350, and after the robotic arm contacts the object, the master policy 200 chooses the second policy 320 with a higher inference cost as the selected sub-policy 350. At time T4 in FIG. 12B, the robotic arm reaches a goal of moving the object to a destination. Between time T2 and T4 in FIG. 12B, time T3 in FIG. 12B is a period of time when the robotic arm is moving the object using the second policy 320.

In FIG. 12C, a horizontal axis is a measurement of time, and a vertical axis is a measurement of rewards in an arbitrary unit, for example, in points. When the walker tries to balance its posture at time T1 in FIG. 12C, the master policy 200 switches between the second policy 320 and the first policy 310 as the selected sub-policy 350. Once the walker reaches the stand-up posture at time T2 in FIG. 12C and tries to maintain a steady posture at time T4 in FIG. 12C, the master policy 200 primarily chooses the first policy 310 as the selected sub-policy 350. Between time T2 and T4 in FIG. 12C, at time T3 in FIG. 12C the walker slightly adjusts its posture for maintaining fine balance by using the second policy 320.

Regarding the above experimental simulation examples, all simulations use both the first policy 310 and the second policy 320 for generating actions. The master policy 200 is able to find a perfect balance between inference cost and satisfying outcome of completing the task. The above experimental simulations all complete their respective tasks successfully. The following table 1 details data regarding the above experimental simulations:

TABLE 1

| | Score for | Score for | | Percentage | Percentage |
|---|---|---|---|---|---|
| | First | Second | Score for | of second | of total |
| | Policy | Policy | Present | policy | FLOPS |
| Environment | only | only | invention | usage | reduced |
| Limb of | 35.5 | 84.1 | 108.8 | 54.9% | 44.6% |
| swimmer | | | | | |
| performing | | | | | |
| stroke | | | | | |
| Car driving | −11.6 | 93.6 | 93.5 | 44.5% | 49.0% |
| up a hill | | | | | |
| Robotic arm | 0.351 | 0.980 | 0.935 | 46.5% | 46.4% |
| moving | | | | | |
| object | | | | | |
| Walker | 330.0 | 977.7 | 967.2 | 5.7% | 82.3% |
| maintaining | | | | | |
| stand-up | | | | | |
| posture | | | | | |

For the same scoring criteria, Table 1 lists scores for each of the experimental simulations using respectively only the first policy 310, only the second policy 320, and a mixture of the first and the second policies 310, 320 as the present invention does to train the controller program. As a result, although unsurprisingly, using only the first policy 310 to generate actions scores the least amount of points, using the present invention scores points very close to using only the second policy 320 to generate actions. In fact, for the experimental simulation of the limb of the swimmer performing the stroke, the present invention scores even higher than using only the second policy 320 to generate actions. This proves the effectiveness of the present invention to generate satisfying results.

Table 1 also lists out the percentage of the second policy 320 used in each of the experimental simulations, as well as a total percentage of FLOPS of the present invention reduced. As a result, for the whole duration of all the experimental simulations, the second policy 320 is used for less than 60% of the time, meaning the first policy 310 is used for more than 40% of the time to reduce inference costs. The total FLOPS reduced signifies an alleviation of computation burden for the processing module 10, and therefore also signifies the inference costs reduced by the present invention. The present invention effectively reduces more than 40% of total FLOPS across all of the experimental simulations. Table 1 proves the effectiveness of the present invention in generating satisfying results, while lowering the inference cost of controlling the action executing unit 20.

The above embodiments and experimental simulations only serve to demonstrate capabilities of the present invention rather than imposing limitations on the present invention. The present invention is free to be elsewise in other embodiments under the protection of what is claimed for the present invention. The present invention may be generally applied to train a control program of any other controlled environments, interactive environments, or simulated environments to reduce computational costs while maintaining quality controls to complete a task.

What is claimed is:

1. A master policy training method of Hierarchical Reinforcement Learning (HRL) with an asymmetrical policy architecture, executed by a processing module, comprising steps of:
step A: loading a master policy, a plurality of sub-policies, and environment data; wherein the sub-policies have different inference costs;
step B: selecting one of the sub-policies as a selected sub-policy by using the master policy;
step C1: generating at least one action signal according to the selected sub-policy;
step C2: applying the at least one action signal to an action executing unit;
step C3: detecting at least one reward signal from a detecting module; wherein the at least one reward signal corresponds to at least one reaction of the action executing unit responding to the at least one action signal; and
step D: calculating a master reward signal of the master policy according to the at least one reward signal and an inference cost of the selected sub-policy;
step E: training the master policy by selecting the sub-policy according to the master reward signal.

2. The master policy training method of HRL as claimed in claim 1, wherein the step D further comprises sub-steps of:
step D1: calculating the master reward signal as a total reward subtracted by a total inference cost of the selected sub-policy for a usage time duration of the selected sub-policy;
wherein the total reward is a sum of all the at least one reward signal for the usage time duration of the selected sub-policy;
wherein the total inference cost of the selected sub-policy correlates to the inference cost of the selected sub-policy and the usage time duration of the selected sub-policy.

3. The master policy training method of HRL as claimed in claim 2, wherein the step D1 further comprises sub-steps of:
step D11: summing the at least one reward signal for the usage time duration of the selected sub-policy as the total reward;
step D12: calculating the master reward signal as the total reward subtracted by the total inference cost of the selected sub-policy for the usage time duration of the selected sub-policy;
wherein the total inference cost of the selected sub-policy equals to the inference cost of the selected sub-policy multiplied by a scaling factor and a time period.

4. The master policy training method of HRL as claimed in claim 3, between step C3 and step D, comprising a step of:
step C4: training the selected sub-policy using the at least one reward signal.

5. The master policy training method of HRL as claimed in claim 1, wherein before executing step C1, the method further comprises:
step C0: sensing a first state information from the environment data, and sending the first state information to the selected sub-policy;
wherein for step C1, the at least one action signal is generated according to the first state information given to the selected sub-policy.

6. The master policy training method of HRL as claimed in claim 2, wherein before executing step C1, the method further comprises:
step C0: sensing a first state information from the environment data, and sending the first state information to the selected sub-policy;
wherein for step C1, the at least one action signal is generated according to the first state information given to the selected sub-policy.

7. The master policy training method of HRL as claimed in claim 3, wherein before executing step C1, the method further comprises:
step C0: sensing a first state information from the environment data, and sending the first state information to the selected sub-policy;
wherein for step C1, the at least one action signal is generated according to the first state information given to the selected sub-policy.

8. The master policy training method of HRL as claimed in claim 4, wherein before executing step C1, the method further comprises:
step C0: sensing a first state information from the environment data, and sending the first state information to the selected sub-policy;
wherein for step C1, the at least one action signal is generated according to the first state information given to the selected sub-policy.

9. The master policy training method of HRL as claimed in claim 5, wherein:
before executing step B, the method further comprises:
step A01: loading a total number, wherein the total number is a positive integer;
repeating steps C0 to C3 for N times, wherein N equals the total number.

10. The master policy training method of HRL as claimed in claim 6, wherein:
before executing step B, the method further comprises:
step A01: loading a total number, wherein the total number is a positive integer;
repeating steps CO to C3 for N times, wherein N equals the total number.

11. The master policy training method of HRL as claimed in claim 7, wherein:
before executing step B, the method further comprises:
step A01: loading a total number, wherein the total number is a positive integer;
repeating steps C0 to C3 for N times, wherein N equals the total number.

12. The master policy training method of HRL as claimed in claim 8, wherein:
before executing step B, the method further comprises:
step A01: loading a total number, wherein the total number is a positive integer;
repeating steps C0 to C3 for N times, wherein N equals the total number.

13. The master policy training method of HRL as claimed in claim 1, wherein step E further comprises sub-steps of:
step E1: training the master policy to select one of the sub-policies based on changes of the environment data, the master reward signal, and the selected sub-policy in time domain.

14. The master policy training method of HRL as claimed in claim 2, wherein step E further comprises sub-steps of:
step E1: training the master policy to select one of the sub-policies based on changes of the environment data, the master reward signal, and the selected sub-policy in time domain.

15. The master policy training method of HRL as claimed in claim 1, wherein:
step A further comprises the following sub-steps:
step A1: loading the master policy, the plurality of sub-policies, and the environment data;
step A2: sensing a first state information from the environment data;
step B further comprises the following sub-steps:
step B1: sending the first state information to the master policy;
step B2: based on the first state information, selecting one of the sub-policies as the selected sub-policy by using the master policy.
